(19) United States
(12) Patent Application Publication
(10) Pub. No.: US 2024/0070369 A1
(43) Pub. Date: Feb. 29, 2024

(54) APPARATUS AND METHOD FOR INTEGRATED CIRCUIT LAYOUTING

(71) Applicant: Intel Corporation, Santa Clara, CA (US)

(72) Inventor: Daniel STAHLKE, Hillsboro, OR (US)

(21) Appl. No.: 18/498,181

(22) Filed: Oct. 31, 2023

(51) Int. Cl. G06F 30/392

(52) U.S. Cl. CPC G06F 30/392; G06F 2111/10

(57) ABSTRACT

The apparatuses for IC layouting comprise interface circuitry, machine-readable instructions, and processing circuitry to execute the machine-readable instructions to obtain a first hierarchical IC layout comprising a first instance of a cell. The cell from which the first instance is derived comprises at least one planar geometric shape representing components of a first IC. The first instance of the cell results from applying a first geometrical transformation operation to the cell during a first instantiation of the cell. Further the processing circuitry is configured to: generate a first hash code of the cell based on a hash function; and generate a second hash code of the first instance of the cell by applying a first mathematical operation to the first hash code. The first mathematical operation is corresponding to the first geometrical transformation operation applied to the cell.

### BACKGROUND

In the evolving domain of integrated circuit (IC) design, IC layouting and IC mask/design layouts play important roles in transmuting circuit designs into real, tangible silicon chips. IC layouting may comprise arranging the various components and interconnections of a circuit in a two-dimensional plane, ensuring optimal performance, reliability, and manufacturability of the resulting IC. Subsequent to the layout process, IC layouts are created, serving as the blueprint for photolithographic processes in semiconductor manufacturing. These layouts may contain the patterns for each layer of the IC, facilitating the precise deposition and etching processes that form the microscopic structures within the silicon substrate. The process of IC layouting and mask creation is important for the accurate realization of modern-day electronic devices, which underpin many contemporary technologies such as smartphones, wearable devices, smart homes, autonomous vehicles, AR/VR devices, AI platforms, 5G networks, industrial automation, IoT devices and the like. However, with an advancement towards higher circuit density and complexity, IC designers and mask layout engineers are faced with the challenge of managing and processing a potentially large number of geometric shapes. Each geometric shape in the layout represents a physical structure on the chip. A large number of geometric shapes may demand the layouting to be managed and processed efficiently. Hence, there may be a demand for improved layouting techniques.

### BRIEF DESCRIPTION OF THE FIGURES

Some examples of apparatuses and/or methods will be described in the following by way of example only, and with reference to the accompanying figures, in which

FIG. 1 illustrates a block diagram of an example of an apparatus;

FIG. 2 illustrates a recursive instantiation of cells into parent cells;

FIG. 3 illustrates a hierarchy of cells in a hierarchical IC layout; and

FIG. 4 illustrates a flowchart of an example of a method.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

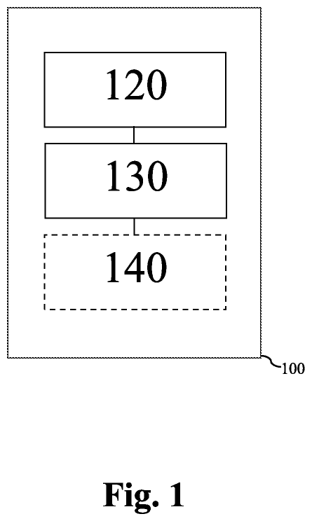

FIG. 1 illustrates a block diagram of an example of an apparatus 100. The apparatus 100 comprises circuitry that is configured to provide the functionality of the apparatus 100. For example, the apparatus 100 of FIG. 1 comprises interface circuitry 120, processing circuitry 130 and (optional) storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120 (for exchanging information, e.g., with other components inside or outside of another computer system) and the storage circuitry 140 (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIGS. 1a and 1b comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

The processing circuitry 130 and/or the interface circuitry 120 is/are configured to obtain a first hierarchical IC layout comprising a first instance of a cell. The cell from which the first instance is derived comprises at least one planar geometric shape representing components of a first IC. The first instance of the cell results from applying a first geometrical transformation operation to the cell during a first instantiation of the cell.

The first hierarchical IC layout comprising the first instance of the cell may be obtained by the processing circuitry 130 through the interface circuitry 120 or another connection from the storage circuitry 140. In another embodiment the first hierarchical IC layout comprising the first instance of the cell may be obtained by the processing circuitry 130 though the interface circuitry 120 from an external source, for example from a server.

IC design is the intricate process of conceptualizing, designing, and optimizing electronic circuits to be fabricated on semiconductor materials. This may involve translating high-level architectural and functional descriptions of the IC into a physical representation through a procedure referred as IC layouting. The result of a layouting process may be a hierarchical IC layout, which may be a layered and organized representation of the physical design of an integrated circuit. In this regard the physical representation of the IC may refer to the detailed layout of how the (electronic) components, such as transistors, capacitors, resistors, and interconnects, are physically arranged and interconnected on a semiconductor wafer (e.g. a silicon, a gallium arsenide, a gallium nitride or a silicon carbide wafer). These components of the IC are represented by planar geometric shapes with a specific size and position of these components on the chip, delineated across various layers of materials, including metals and insulators.

The planar geometric shapes representing components of the first IC may be a geometric figure within a two-dimensional plane of the hierarchical IC layout. The planar geometric shape may be a polygon such as a triangle, a rectangle etc., a circle, or a (non-polygonal shape) shape or curve such as 6ezier splines or the like.

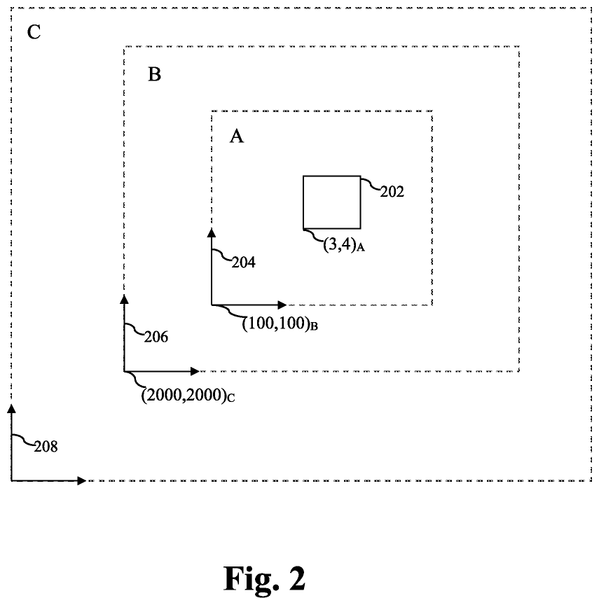

The first hierarchical IC layout (also referred to as IC design, or layout) may consist of a large number, for example many billions, of these planar geometric shapes representing components of the IC. Therefore, planar geometric shapes, for the sake of efficiency, may be stored hierarchically. The hierarchical representation may be obtained by arranging several planar geometric shapes into single structure referred to as a cell. A cell may be utilized several times in a hierarchical layout (see also FIG. 2) or may be used in a different hierarchical IC layout. For example, specific patterns of planar geometric shapes which may be repeated several times in the hierarchical layout may be stored in a cell. A stored cell that is placed into a specific hierarchical layout at a specific coordinate is referred to as an instance of the cell (also placement of a cell). That is the first instance of the cell is a concrete (specific) occurrence of the cell placed at a specific location with specific coordinates within the first hierarchical layout. A cell may be placed into a specific hierarchical layout many times at different specific locations. Cells and instances of cells may be used recursively, that is a cell in turn, may be composed of multiple smaller cells etc. An instance of a cell may be placed in another cell which may be again placed in another cell. A cell comprising an instance of another cell. May be referred to as a parent cell wherein the included instance of the cell may be referred to as a child cell. A cell that is containing all of the cells and geometrical shapes of a specific hierarchical IC layout is referred to as a root cell. The hierarchical structure of the layout may provide efficient storage and management.

The hierarchical IC layout is a representation of an IC by planar geometric shapes. The planar geometric shapes are representing components of the IC. The components of the IC, e.g., comprise patterns of metal, oxide, insulation and/or semiconductor layers. The planar geometric shapes are structured in layers of nested instances of one or more cells. The hierarchical IC layout may be stored and processed as hierarchical IC layout data in a specific format. For example, the hierarchical IC layout comprises the coordinates of the cells and/or geometric shapes and information about the hierarchical nesting and further information. For example, the hierarchical IC layout data may have the Open Artwork System Interchange Standard (OASIS) data format or the GDSII data format.

For example, the IC layout may be a mask layout, that represents a photolithographic mask, which is used to manufacture a desired IC end product. In another example, the IC layout may be design layout (for example designed by a circuit designer), that represents what the end product should look like. Due to complexities of the lithography process, a design layout and a mask layout may look different.

A final collection of all geometric shapes in a hierarchical IC layout, with all repetitions of cells expanded out such that there is no more nested and hierarchical structure, is referred to as an IC flattened layout (also referred to just as flattened layout). There are many different possible hierarchical layouts that can correspond to the same flattened layout representing the same physical design of an integrated circuit. That is because the hierarchical arrangement of cells for the same physical design of an integrated circuit may be done differently. Therefore, given two hierarchical IC layouts, it may be desired to check whether the corresponding flattened layouts are identical.

A hierarchical IC mask layout may be used in the semiconductor fabrication process. It provides the blueprints needed to produce a series of photolithographic masks. These masks, in turn, guide the deposition, etching, and doping processes during chip manufacturing, ensuring that every layer and component of the IC is crafted to the specific design specifications. That is, the hierarchical IC mask layout acts as the bridge between a chip's abstract design and its physical realization in silicon. Therefore, a fast and efficient checking if two hierarchical IC mask layouts represent the same physical design of an integrated circuit may be desirable for the IC fabrication process.

A cell, comprising one or more geometric shapes and/or one or more other cells may have its own cell coordinate system. The one or more geometric shapes and/or the one or more other cells are positioned and measured within that cell coordinate system. A planar geometric shape may be represented as a list of planar coordinates S={(x₁, y₁), . . . , (x_{q}, y_{q})}. The q points in the list S (the points in the list may be ordered) may be the coordinates of some or all vertices of the planar geometric shape or points on the planar geometric approximating (for example in case of a Bezier curve) its shape closely. Further, the cell C may be represented by a list of all K planar coordinates {(x₁, y₁), . . . , (x_{qi}, y_{qi})}ᵢ of all i=1, . . . , K planar geometric shapes in the cell as {{(x₁, y₁), . . . , (x_{q1}, y_{q1})}₁, . . . , {(x₁, y₁), . . . , (x_{qK}, y_{qK})}_{K}}. The coordinates of the points included in the cell may be denoted in the cell coordinate system. Further, the representation of the cell C may comprise representations of a plurality of L cells, C₁, . . . , C_{L}, included in the cell which may be transformed one or more times. This yields a representation of the cell C as follows:

C={{(x₁, y₁), . . . , (x_{q1}, y_{q1})}₁, . . . , {(x₁, y₁), . . . , x_{qK}, y_{qK})}_{K}, C₁, . . . , C_{L}} (Equation 1).

In another example, a representation of the cell C may also include the transformations of the plurality of L cells, C₁, . . . , C_{L} as follows:

C={{(x₁, y₁), . . . , (x_{q1}, y_{q1})}₁, . . . , {(x₁, y₁), . . . , (x_{qK}, y_{qK})}_{K}, (C₁, t₁), . . . , (C_{L}, t_{L})} (Equation 1a).

When a cell is instantiated, that is an instance of a cell is generated, a geometrical transformation operation may be applied to the cell in order to generate the instance of a cell at a specific location with a specific geometric alignment within the parent cell. A cell may be instantiated within the coordinate system of a parent cell in which that instance of the cell is placed. Therefore, the cell is instantiated within the coordinates of its parent cell. Therefore, a geometrical transformation operation is applied to a cell and all geometrical shapes within that cell when it is instantiated within a parent cell. A default placing of a cell during instantiation of the cell into a parent cell may be to place it at the origin of its parent coordinate system. Therefore, a geometrical transformation operation applied to a cell during instantiation may be a geometrical transformation operation applied to the cell within the coordinate system of the parent cell. The geometrical transformation operation may be applied to the cell positioned in default placing, for example at the origin of the parent cell. This applies recursively, that is a cell to which a geometrical transformation operation is applied within the coordinates of its parent cell is again geometrically transformed when the parent cell is instantiated into a further parent cell (for example the root cell). That is a geometrical transformation operation is applied to the parent cell within the further parent cell. Each instance of a cell may have corresponding coordinates in each parent cell hierarchically above it. Therefore, ultimately a cell has corresponding coordinates in the root cell coordinate system of the hierarchical IC layout (see also FIG. 2).

The first geometrical transformation operation may comprise shifting, rotating and/or mirroring the cell within the coordinate system of the parent cell. The first geometrical transformation operation may be represented by a mathematical function t(⋅) which is applied to the cell. During instantiation of the cell the geometrical transformation operation is applied to the cell. The geometrical transformation operation is applied to the cell within the coordinate system of the parent cell. The geometrical transformation operation may be applied to the cell positioned in default placing, for example at the origin of the parent cell (that is the coordinates are the same as in the own coordinate system of the cell). The geometrical transformation operation of the cell C during instantiation, represented by a mathematical function t(⋅), yields a representation of the instance of the cell C_{instance} in the coordinates of its parent cell as follows:

C_{instance}=t(C) (Equation 2).

FIG. 2 illustrates a recursive instantiation of cells into parent cells. Cell A has its own coordinate system 204 and comprises as a planar geometrical shape, that is a rectangle 202. Within the coordinate system 204 the rectangle 202 has the coordinates (3,4)_{A}. Cell A is instantiated into cell B. During instantiation a geometrical transformation operation of shifting (also referred to as translation) is applied to cell A, within the coordinate system 206 of the cell B. Cell B is a parent cell of cell A. Cell A is a child cell to parent cell B. The shifting operation is applied with regards origin of cell A (in another embodiment the shifting is applied with regards to the centroid, also referred to center of mass of cell A and/or a geometric shape). Cell A is shifted 100 to the right and 100 up from the origin of coordinate system 206 of cell B. The rectangle 202 has coordinate (103, 104)_{B} within the coordinate system 206 of cell B. Cell B is instantiated into the root cell C. During instantiation a geometrical transformation operation of shifting is applied to the cell B, within the coordinate system 208 of the cell B. Cell C is a parent cell of cell B, which is a child cell to parent cell C. The shifting operation is applied with regards to the origin of cell B. Cell B is shifted 2000 to the right and 2000 up from the origin of the coordinate system 208 of root cell C. The rectangle has coordinates (2103, 2104)_{C} within the coordinate system 208 of the root cell C. Root cell C contains one instance of cell B and cell B contains one instance of cell A.

The processing circuitry 130 is configured to generate a first hash code of the cell based on a hash function. A hash function is a mathematical algorithm that takes an input and returns a fixed-size string of characters, which may be a sequence of numbers referred to as hash code (or hash value). A hash function may strive to assign distinct hash values to different inputs. Collisions, where different inputs produce the same hash value, are possible but rare and a hash function may ensure that similar inputs produce vastly different hash codes. Further, it may be computationally infeasible to generate the original input value given only the hash code, and even small changes in the input may generate vastly different hash codes. This makes hash codes sensitive detectors of even minor input data alterations. In other words, the hash function based on which the first hash code of the cell is generated maps geometric data (polygons) to a short array of numbers (the hash value). The first hash code may be a hash code of the cell, that is a “non-instantiated” cell.

The processing circuitry 130 is configured to generate a hash code of the planar geometric shape of the cell by applying the hash function to the planar geometric shape. The hash function hash(⋅) may be applied to the list of planar coordinates S of the planar geometric shape and yield the hash code hc=hash(S).

Further, the processing circuitry 130 is configured to generate the first hash code hc₁ of the cell, by generating a hash code for all instances of cells and all planar geometric shapes in the cell and combining the resulting hash codes. For example, combining may be summing. In case that the cell only comprises one planar geometric shape the first hash code hc₁ of the cell is determined by applying the hash function hash(⋅) to the list of planar coordinates S of the planar geometric shape as

hc₁=hash(S) (Equation 3).

In case that the cell comprises a plurality of K planar geometric shapes the first hash code hc₁ of the cell is determined by applying the hash function hash(⋅) to each of the planar geometric shapes in the list S={S₁, . . . , S_{K}}, and then summing them together as:

hc₁=hash(S)=Σᵢ₌₁^{K} hash(Sᵢ) (Equation 4).

In case that the cell C comprises a plurality of K planar geometric shapes and a plurality of L child cells, the first hash code hc₁ of the cell is determined by applying the hash function hash(⋅) to each of the planar geometric shapes in the list S={S₁, . . . , S_{K}} and then summing them together. Further, by determining the hash codes of all cells hc_{c}_{₁}, . . . , hc_{c}_{_{L}} then summing them together and summing both sums together as follows:

hc₁=hash(C)=Σᵢ₌₁^{K}hash(Sᵢ)+Σⱼ₌₁^{L}hc_{c}_{ⱼ} (Equation 5).

Further the processing circuitry 130 is configured to generate a second hash code of the first instance of the cell by applying a first mathematical operation to the first hash code. The first mathematical operation is corresponding to the first geometrical transformation operation applied to the cell. The first instance of the cell is an instance of the cell, that is instantiated in the first hierarchical IC layout. It can be instantiated in the root cell of the first hierarchical IC layout or in any other parent cell that is placed in the first hierarchical IC layout. The first mathematical operation may be represented by the function ƒ₁(⋅), which receives as input the first hash code hc₁ and maps it to the second hash code hc₂,

hc₂=ƒ₁(hc₁) (Equation 6).

As described above the first instance of the cell is generated by applying the first geometrical transformation operation, represented by the mathematical function t₁(⋅) to the cell C placed (at the default position of the origin) within the coordinate system of the parent cell. The first mathematical operation (ƒ₁(⋅)) is corresponding in such a way to the first geometrical transformation operation (t₁(⋅) applied to the cell (C) that, applying the hash function (hash(⋅)) to the cell geometrically transformed by the first geometrical transformation operation (t₁(C)) yields the same hash code (hc₂) as applying the corresponding first mathematical operation (ƒ₁(⋅)) to the first hash code (hc₁). This may be also expressed in the following equation:

hc₂=ƒ₁(hash(C))=ƒ₁(hc₁)=hash(t₁(C)) (Equation 7),

with hash(C)=hc₁ according to equation (5). In other words, the second hash code hc₂ is equal to a hash code hash(t₁(C)) obtained by applying the hash function to the first instance of the cell. In other words, the hash function condenses the planar geometric shape from each cell into a hash code (which may be considered as a concise numerical fingerprint). The hash function and corresponding mathematical operations are defined such that these mathematical operations (also referred to as mathematical transformations), that can be performed on the hash code, are equivalent to performing geometric transformation operations on the input geometry (cell or planar geometric shape). The generated hash code supports the geometric transforms of translation (shift), rotation, mirroring (reflection), and placement. This allows to combine the hash codes of the cells of a hierarchical IC layout into a hash code representing the total flattened layout of the IC. In other words, the above described hash function is insensitive to changes in hierarchical structure of an IC layout.

For example, a hash code (full hash code) for a given cell (or planar geometric shape) may comprise a list of hash codes/hash values. For example, in one implementation the hash code may comprise a list of 8 hash codes/hash values (see below).

The hash codes/hash values may be implemented with a different data length, for example the hash code may be a 64 bit integer (integers in the range 0 to 2⁶⁴−1).

The generation of a hash code by applying a hash function to a cell may be time consuming and require large computing capacities. That is especially the case if the cell comprises a plurality of planar geometric shapes and/or a plurality of child cells that may again comprise a plurality of child cells. All child cells included in the instance of the cell may first be flatten out to the lowest hierarchy layer (that is the layer of the planar geometric shapes) such that the hash function may be applied to determine the hash code. Contrary to that, applying a mathematical operation to a hash code may be very fast and require little computing capacities compared to applying the hash function to the cell. Therefore, generating the second hash code with the above described technique, may be much faster and require much fewer computing capacities than generating the second hash code by applying the hash code to the first instance of the cell. For example, the above described technique may enable a rapid validation of the accuracy of hierarchy manipulation algorithms of ICs.

The processor circuitry 130 is configured to generate a third hash code of a second instance of the cell by applying a second mathematical operation to the first hash code. The second instance of the cell results from applying a second geometrical transformation operation to the cell during a second instantiation of the cell. The second instance of the cell is an instance of the same cell as the first instance. It may be instantiated in the first hierarchical IC layout in the same parent cell as the first instance of the cell or in any other parent cell in first hierarchical IC layout or it may be instantiated in a second hierarchical IC layout. The second instance of the cell is generated by applying the second geometrical transformation operation, represented by the mathematical function t₂(⋅), to the cell C placed (at the default position of the origin) within the coordinate system of its parent cell.

The second mathematical operation is corresponding to the second geometrical transformation operation applied to the cell. The second mathematical operation may be represented by the function ƒ₂(⋅), which receives as input the first hash code hc₁ and maps it to the third hash code hc₃, which may be expressed according to equation (6) as follows:

hc₃=ƒ₂(hc₁) (Equation 8).

Accordingly, as described above, the second mathematical operation is corresponding in such a way to the second geometrical transformation operation applied to the cell that applying the hash function to the cell geometrically transformed by the second geometrical transformation operation yields the same hash code as applying the corresponding second mathematical operation to the first hash code. This may be expressed in the following equation, corresponding to equation (7):

hc₃=ƒ₂(hash(C))=ƒ₂(hc₁)=hash(t₂(C)) (Equation 9),

with hash(C)=hc₁ according to equation (5).

Different mathematical operations may correspond to different geometrical transformation operations (which may comprise shifting, rotation, mirroring). The different mathematical operations may be defined in such a way that they fit the definition of the hash function, such that equations (7) and (9) may be fulfilled.

As described above generating the third hash code with the above described technique, may be much faster and require much fewer computing capacities than generating the third hash code by applying the hash code to the second instance of the cell. Furthermore, if a cell is instantiated multiple times (for example thousands or millions of times in a hierarchical IC layout), the hash code of the cell may be generated once, and then the hash codes of the multiple instances of the cells may be determined very fast and efficiently based on the mathematical operation corresponding to the geometrical transformation operation applied during instantiation as described above.

The processing circuitry 130 is configured to generate a hash code for each instance of a cell in the first hierarchical IC layout. The processing circuitry 130 may generate a hash code of each cell that is placed within the first hierarchical IC layout by applying the hash function to the cell (this may imply to recursively applying the hash function to cells and/or geometrical shapes included in each cell). Then processing circuitry 130 may generate all or some instances of all or some cells placed in the first hierarchical IC layout based on a mathematical operation corresponding to the geometrical transformation operation applied during instantiation of the respective cell as described above. This may yield a hash code for each instance of a cell within the first hierarchical IC layout. There may be multiple instances of multiple cells within the first hierarchical IC layout.

The processing circuitry 130 is further configured to generate a hash code for the first hierarchical IC layout by combining all the generated hash codes of all instances of all cells. The hash codes of all instances of all cells in the first hierarchical IC layout may be combined by summing them up to obtain a hash code for the first hierarchical IC layout.

The generation of the hash code for the first hierarchical IC layout with the above described technique, may be much faster and require much fewer computing capacities than if the hash code for each instance of each cell is generated “from scratch” by applying the hash function to it.

The processing circuitry 130 is configured to generate a hash code for a second hierarchical IC layout. The processing circuitry 130 may generate the hash code for a second hierarchical IC layout similar as the hash code for the first hierarchical IC layout. That is the hash codes of all or some instances of all or some cells placed in the second hierarchical IC layout may be generated based on a mathematical operation corresponding to the geometrical transformation operation applied during instantiation of the respective cell as described above. Therefore, the generation of the hash code for the second hierarchical IC layout with the above described technique, may be much faster and require much fewer computing capacities than if the hash code for each instance of each cell is generated “from scratch” by applying the hash function to it.

The processing circuitry 130 is further configured to compare the first hierarchical IC layout and the second hierarchical IC layout for similarity by comparing the corresponding hash codes. The hash code of a specific hierarchical IC layout may be determined by combining (for example summing), the hash codes of all the cell instances in the hierarchical IC layout. Therefore, a hash code corresponding to a specific physical IC (and a specific flatten IC layout) is invariant under all possible different hierarchical structuring of the cells into different hierarchical IC layouts representing the physical IC. Therefore, two or more given different hierarchical IC layouts may be compared for similarity, for example to find out whether they represent the identical physical IC, by comparing the corresponding hash codes of the different hierarchical IC layouts.

Comparing the first hierarchical IC layout and the second hierarchical IC layout for similarity by comparing the corresponding hash codes may comprise to check whether the two hash codes are identical. If they are identical that may indicate that first hierarchical IC layout and the second hierarchical IC layout represent the same physical IC.

Previously in order to compare the two or more hash codes of different hierarchical IC layouts, the flattened layout for each of the hierarchical layouts had to be computed and then an equality comparison between the flattened layouts was determined. Another previously performed method to compare the two or more hash codes of different hierarchical IC layouts was to generate a hash code for each of the different hierarchical IC layouts from flattened layouts and compare the generated hash codes. However, the flattened layout typically consists of many billions of planar geometric shapes, whereas the planar geometric shapes count in the hierarchical representation may be orders of magnitude lower. Therefore, the technique as described above—to fast and efficiently generate a hash code for each of the different hierarchical IC layouts—may perform the comparison orders of magnitude faster.

As described above a hierarchical IC layout may be used in the IC fabrication process for example to provide blueprints which are needed to produce photolithographic masks. These masks, in turn, guide the deposition, etching, and doping processes during IC chip manufacturing, ensuring that every layer and component of the IC is crafted to the specific design specifications. Therefore, it may be desirable to determine if two or more hierarchical IC layouts represent the same physical design of an IC, for example for potential reusage of (parts of) already available expensive photolithographic masks or the like. Further, it may be determined if two or more hierarchical IC layouts represent the same physical design of an IC in order to validate the output of an algorithm that performs hierarchy manipulations. Therefore, a fast and computationally efficient comparison technique, as described above, improves, speeds up and cheapens IC manufacturing. This technique may reduce layout comparison time from for example several hours to for example under a minute. For example, the above described technique may be used in EDA (electronic design automation) or CAD (computer aided design) software.

Therefore, the above described technique may speed up IC layout comparison. This enables real-time feedback on intricate layout modifications, ensuring optimal adherence to stringent nanoscale lithography constraints. As EUV (Extreme Ultraviolet) lithography and multi-patterning techniques may be used (for example in sub-7 nm design nodes), the ability to rapidly compare and contrast layout patterns may become more important in ensuring lithographic fidelity, minimizing stochastic failures, and optimizing overlay accuracy. Further, the technique may reduce pattern matching times, directly enhancing the DRC (Design Rule Check) and LVS (Layout Versus Schematic) validation stages. This technical acceleration not only curtails the design-to-silicon cycle but also ensures that layout intricacies align seamlessly with the ever-evolving fabrication processes, promoting optimal chip performance and yield.

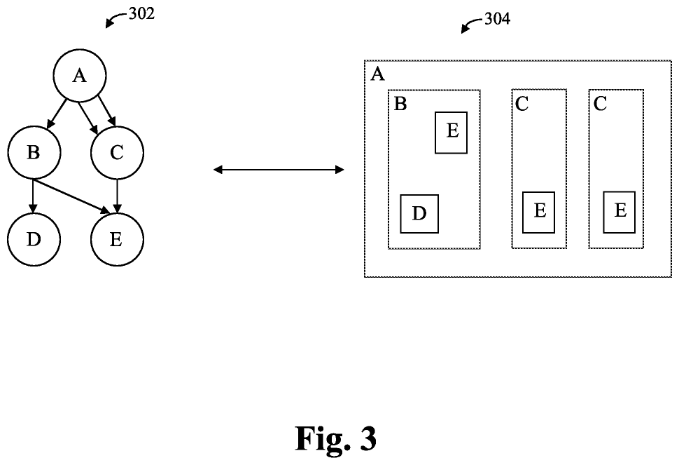

FIG. 3 illustrates a hierarchy of cells in a hierarchical IC layout. Graph 302 illustrates a graph representation of the hierarchical cell structure in the IC layout and denotes schematically the relationships of the cell instantiations. The 2D illustration of the IC 304 shows how the cell instantiations are physically placed within the hierarchical IC layout. There are five cells, denoted as A, B, C, D, and E. Within cell A, which may be the root cell of the hierarchical IC layout, there is one copy of cell B and two copies of cell C placed. Cells B and C are child cells of the parent cell A. Cell B contains an instance (also referred to as placement,) of cell D and cell E. Cell E is additionally instantiated (placed) within cell C. Further, the cells, in addition to containing placements of child cells, may contain further planar geometric shapes. Ultimately the planar geometric shapes are important in the final IC layout. In FIG. 2 three copies of cell E are placed in the layout, and so planar geometric shapes in these cells need to be specified only once rather than three times. For example, during IC layouting a single cell may be placed thousands or millions of times or the like. This sort of hierarchical description of geometric data sees widespread use in EDA (electronic design automation) and CAD (computer aided design) software. Each child cell (e.g., the two instantiations of cell C within parent A) is placed within its parent at a specified offset and with a specified rotation and optional mirroring (that is a geometrical transformation is applied during instantiation of the cell in the parent cell). Therefore, an advantage of such a hierarchical representation is efficiency.

As described above, a previous standard way to compute a hash value of hierarchical IC layout as for example illustrated in FIG. 3 would be to first flatten it into a simple list of planar geometric shapes (for example polygons). For example, the planar geometric shapes associated with cell E would need to be instantiated three times (two times in each of cell C and one time in cell B), corresponding to the three placements of cell E. Similarly, the planar geometric shapes from cell C would need to be instantiated two times in the (root) cell. Then the hash value of the flattened list of polygons could be computed. Given that realistic layouts can contain thousands or millions of instantiations of a given cell, this is very inefficient.

Using the technique as described above the hash value of the hierarchical layout can be computed much more efficiently. Referencing the hierarchy depicted in FIG. 3, first the hash function is used to compute a hash code for the planar geometric shapes contained within cell E. Then the same would be performed for cell C, but instead of directly instantiating the polygons from the child cell E, the already computed hash code for cell E is used. As described above, the hash code of cell E can be transformed (manipulated) to simulate geometrical transformation operations such as translation, rotation, or mirroring of geometry. Therefore, the hash code of cell E's geometry is transformed in a way corresponding to the placement location of an instance of cell E within cell C. This computation proceeds, recursively, with hash codes of child cells used in construction of the hash codes of parent cells, until a hash value for cell A (the root cell) is obtained. The hash code for the root cell A (or the hierarchical IC layout) thus computed is equivalent to a hash code that would be obtained from considering the planar geometric shapes of the flattened IC layout directly. Different hierarchical representations corresponding to the same flattened layout will have identical hash codes.

### Examples of Hash Functions and Mathematical Operations

The hash function may have different forms. For example, the coordinates of the planar geometric shape may be interpreted as a polynomial over a finite field and this polynomial may be evaluated at a random point. These kinds of hash functions are known in cryptography, for example the “Poly1305” universal hash family. Further, these hash functions are known in theoretical computer science, for example as described in the book “Communication Complexity”, by Kushilevitz and Nisan, published by Cambridge University Press, 1996.

However, in this case it is important to design the hash function hash(⋅) (and the according mathematical operations) in such a way that the equations (7) and (9) hold. That is the hash function exploits the mathematical properties of such a construction in order to simulate geometric transformations of the input data. Therefore, unlike known techniques which are based on univariate polynomials, the hash function used for the technique described above may be based on a bivariate polynomial function. A bivariate polynomial function is a polynomial in two variables, for example u, v.

In a first example, the hash function may be based on a bivariate polynomial function, wherein the exponents of the polynomial functions are based on the coordinates of the planar geometric shape, represented as a list of planar coordinates S={(x₁, y₁), . . . , (x_{q}, y_{q})}. Further, the bivariate polynomial hash function may be evaluated at a randomly chosen point (u, v). For example, the hash code hc of the planar geometric shape S may be determined by applying the hash function hash(⋅) according to a mathematical formula which is equivalent to the following formula:

$$hc = hash ( S ) = {\sum }_{\begin{matrix}vertical edges i \\ in the planar \\ geometric shape\end{matrix}} [ {u}^{{x}_{i}} ( {v}^{{y}_{i , 1}} - {v}^{{y}_{i , 2}} ) mod p ] + {\sum }_{\begin{matrix}non - vertical , \\ non - horizontal \\ edges j in the \\ planar geometric \\ shape\end{matrix}} [ ( ( {u}^{{x}_{j , 1}} {v}^{{y}_{j , 1}} - {u}^{{x}_{j , 2}} {v}^{{y}_{j , 2}} ) {s}^{{a}_{j}} {t}^{{b}_{j}} mod p ] , \qquad ( Equation 10 )$$

The planar geometric shape S may comprise a number of i=1, . . . , V₁ vertical edges, which may be represented by the coordinates xᵢ, y_{i,1}, y_{i,2}. Furthermore, planar geometric shape S may comprise a number of j=1, . . . , V₂ non-vertical and non-horizontal edges which may be represented by the coordinates x_{j,1}, y_{j,1}, x_{j,2}, y_{j,2}. Furthermore, aⱼ is a numerator and bⱼ is a denominator of a reduced fraction of a slope between the two vertices of a respective edge j∈{1, . . . , V₂}. Furthermore, u, v, s, t are randomly chosen but fixed numbers of bit-length N. For example, the numbers are chosen by a random generator. N is an integer number. Furthermore, mod is a modulo operator and p is the largest prime number less than 2^{N}. Superscripts denote exponentiation.

In case that the planar geometric shape may be a polygon consisting of only horizontal and vertical edges, all but the vertical edges are discarded (which, alone, may be enough to encode all information about the full polygon). In that case the second summation term in equation (10) may not be necessary to generate the hash code of the polygon.

For example, N=32, or N=64 or N=128 or the like, so that p is the largest prime number less than 2³² or 2⁶⁴ or 2¹²⁸ and u, v, s, t are randomly chosen but fixed 32-bit or 64-bit or 128-bit numbers. For example, the coordinates xᵢ, y_{i,1}, Y_{i,2} correspond to the two endpoints of edge i, as the edges i={1, . . . , V₁} may be enumerated in a clockwise ordering around the polygon (same for the edges j∈{1, . . . , V₂}.

Different mathematical operations may correspond to different geometrical transformation operations. The (first/second) geometrical transformation operations may comprise shifting, rotation, mirroring of a cell. The different mathematical operations are defined such that equations (7) and (9) are fulfilled.

For the hash function hash(⋅) as described above with regards to the first example, a mathematical operation corresponding to a shifting (also referred to as translation) of the cell (or a planar geometric shape) may be determined according to a mathematical formula which is equivalent to the following formula:

hc₂=(hc₁·u^{dx}·v^{dy})mod p (Equation 11)

The hash code hc₁ is the hash code of the cell which may be generated based on the hash hash(⋅) as described above. The hash code hc₂ is the hash code of the (shifted) first instance of the cell. Further, the terms dx, dy are the shifting offset in x-direction and y-direction (within the coordinate system of the parent cell, measured for example from the origin) applied to the cell during the first instantiation. Furthermore u, v are randomly chosen but fixed numbers of bit-length N. Further, N is an integer number and p is the largest prime number less than 2^{N}.

The hash code of the union of geometries (i.e., cells or planar geometric shapes) may be determined as the sum of the hash codes of each component. For example, if a hierarchical (parent) cell contains a geometry (cell) with hash code hc, and that cell is placed two times with offsets (dx₁, dy₁) and (dx₂, dy₂), then the hash code corresponding to the union of the geometry of these two placements is [(hc·u^{dx}^{₁}·v^{dy}^{₁})+(hc·u^{dx}^{₂}·v^{dy}^{₂})]mod p.

Further, for the hash function hash(⋅) as described above with regards to the first example, for a mathematical operation corresponding to a rotation the cell (or a planar geometric shape) a hash value (as described above) for all four possible rotations (0, 90, 180, and 270 degree) is considered. Correspondingly, for the hash function hash(⋅) as described above with regards to the first example, for mathematical operation corresponding to a minoring of the cell (or a planar geometric shape) four possible mirrorings (also referred to as reflections) are considered. The four possible mirrorings are: Minoring on a horizontal axis (e.g., x-axis), mirroring on a vertical axis (e.g., y-axis), mirroring on a first diagonal axis and mirroring on a second diagonal axis. This results in eight possible pairs of rotations and mirrorings. For example, equation (10) is applied to one, or more, or all eight different rotations and mirrorings of a planar geometric shape S or a cell, and the corresponding hash codes are stored for the planar geometric shape S or cell: hc, hc_{90°}, hc_{180°}, hc_{270°}, hc_{mirroring 1} hc_{mirroring 2}, hc_{mirroring 3}, hc_{mirroring 4}. All eight of these hash codes may be referred to as a full hash code of the planar geometric shape S or cell. Even if the eight hash codes are determined for each the planar geometric shape S or cell beforehand, the above described technique is orders magnitude faster than computing a hash code for the flattened layout.

In another example, the hash codes of the corresponding rotation/mirroring are determined according to equation (10) in the moment they are needed during determining the hash code for the root cell.

To the hash codes corresponding to the rotations and mirrorings hc, hc_{90°}, hc_{180°}, hc_{270°}, hc_{mirroring 1}, hc_{mirroring 2}, hc_{mirroring 3}, hc_{mirroring 4}, a mathematical operation corresponding to a shifting as described above with regards to equation (11) may then be applied., That is, if a cell is shifted after a mirroring/reflection was applied (that is if the shifting is applied to any of the eight-component hash code), the shifting offset (dx, dy) may be transformed accordingly into the rotated and mirrored coordinate frames.

Further, to the eight rotations/mirrorings (also referred to as symmetries) as described above may be referred to as the symmetry group of the square, which is also known as the dihedral group D₄. Furthermore, a hash code for the cell (or planar geometric shape) acted upon by each member of the dihedral group D₄ will be determined by applying the hash function hash(⋅) as given in equation (10). In one example, the full hash code of the cell may comprise the eight hash codes (for example eight 64-bit numbers). Then rotations and mirrorings of the cell correspond to permutations among these eight numbers. To support rotations and mirrorings, the full hash code (that is the list of the eight hash codes) are tracked. Rotation and mirroring operations correspond to a permutation of the eight hash codes of the dihedral group D₄. For example, a rotation by 90 degrees would yield the mapping:

(hc, hc_{90°}, hc_{180°}, hc_{270°}, hc_{mirroring 1} hc_{mirroring 2}, hc_{mirroring 3}, hc_{mirroring 4})→(hc_{90°}, hc_{180°}, hc_{270°}, hc, hc_{mirroring 3} hc_{mirroring 4}, hc_{mirroring 2}, hc_{mirroring 1}).

There are corresponding permutations for each of the eight rotation/mirroring operations.

Further, an IC layout may assign a layer to planar geometric shapes, which may correspond to the layer in IC on which that planar geometric shape will be printed. Layer information may be encoded into the hash codes by multiplying a hash code hc by a factor r^{l} where r is a randomly chosen (but fixed) number (for example a 64-bit number or the like) and l is an integer number corresponding to the layer of the planar geometric shape.

Further, the hash function and the corresponding mathematical operation described above may have the additional beneficial property of being invariant to fracture lines of planar geometric shapes. For example, a combined hash code of two smaller abutting planar geometric shapes (for example two smaller rectangles) is equal to the hash code of the equivalent single larger planar geometric shape (for example a larger rectangle).

In a second example, the hash function may be based on a bivariate polynomial function, wherein the variables of the polynomial function may be based on the coordinates of the planar geometric shape, represented as a list of planar coordinates S={(x₁, y₁), . . . , (x_{q}, y_{q})}. For example, the hash code hc of the planar geometric shape S may comprise a list of hash values hᵢ i=1, . . . , M. A hash value hᵢ is determined by applying the hash function according to a mathematical formula which is equivalent to the following formula:

hash(S, (m, n)ᵢ)=h_{(m,n)}_{ᵢ}=Σ_{(x,y) integer coordinates in geometric shape} xⁿ y^{m} (Equation 12)

hc={h_{(m, m)}_{₁}, . . . , h_{(m,n)}_{_{M}}} (Equation 13)

A hash value h_{(m,n)}_{ᵢ} may be determined for each pair (m, n)ᵢ which satisfies (m+n)ᵢ≤N, with M pairs satisfying this condition, that is i∈{1, . . . , M}. Thereby, m, n are non-negative integers and N is a predetermined integer (for example 4 or 8 or the like). Further, x, y are the coordinates for the respective planar geometric shape, that is for example {(x₁, y₁), . . . , (x_{q}, y_{q})}.

In other words, the hash code comprises hash values (that may be considered as “raw moments of order n+m”) (xⁿ, y^{m}), summed over (x, y) coordinates covered by the planar geometric shape, for several small values of n, m fulfilling the condition as described above.

Further, different mathematical operations which correspond to different geometrical 20 transformation operations (like shifting, rotation, minoring) of a cell may be defined for the second example of the hash function as well. These different mathematical operations are defined such that equations (7) and (9) are fulfilled. For the hash function hash(⋅) as described above with regards to the second example, a mathematical operation corresponding to a shifting of the cell (or a planar geometric shape) may be determined according to a mathematical formula which is equivalent to the following formula:

$${\hat{hc}}_{( m , n )} = {\sum }_{k = 0}^{n} {\sum }_{j = 0}^{m} ( \begin{matrix}n \\ k\end{matrix} ) ( \begin{matrix}m \\ j\end{matrix} ) {h}_{( k , j )} d {x}^{( n - k )} d {y}^{( m - j )} \qquad ( Equation 14 )$$

A hash value hc_{(m,n)} may be generated based on the hash function hash(⋅) as described above in equation (12). The hash value [symbol] _{(m,n)} is the hash value of the (shifted) first instance of the cell. Further, the terms dx, dy are the shifting offset in x-direction and y-direction applied to the cell during the first instantiation. This may be applied to all hash values h(m, n)ᵢ of the hash code hc.

With regards to rotation/mirroring the same as described above with regards to the first example may apply here, too.

In another example, equations 12 and 14 may optionally be reduced modulo a prime number p (or composite number) which may be chosen for example as described (for example p being the largest prime number less than 2^{N} with N being an integer number for example 32, 64, 128 or the like).

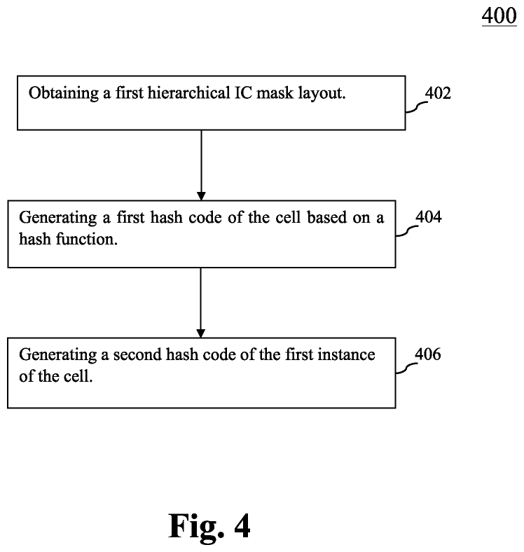

FIG. 4 illustrates a flowchart of an example of a method 400. The method 400 comprises obtaining 402 a first hierarchical IC layout data comprising a first instance of a cell, wherein the cell from which the first instance is derived, comprises at least one planar geometric shape representing components of a first IC. The first instance of the cell results from applying a first geometrical transformation operation to the cell during a first instantiation of the cell. The method 400 further comprises generating 404 a first hash code of the cell based on a hash function. The method 400 further comprises generating 406 a second hash code of the first instance of the cell by applying a first mathematical operation to the first hash code. The first mathematical operation is corresponding to the first geometrical transformation operation applied to the cell.

More details and aspects of the method 400 are explained in connection with the proposed technique or one or more examples described above (e.g., FIG. 1). The method 400 may comprise one or more additional optional features corresponding to one or more aspects of the proposed technique, or one or more examples described above and below.

In the following, some examples of the proposed concept are presented:

An example (e.g., example 1) relates to an apparatus for integrated circuit, IC, layouting comprising interface circuitry, machine-readable instructions, and processing circuitry to execute the machine-readable instructions to obtain a first hierarchical IC layout comprising a first instance of a cell, wherein the cell from which the first instance is derived comprises at least one planar geometric shape representing components of a first IC, and wherein the first instance of the cell results from applying a first geometrical transformation operation to the cell during a first instantiation of the cell, generate a first hash code of the cell based on a hash function, and generate a second hash code of the first instance of the cell by applying a first mathematical operation to the first hash code, wherein the first mathematical operation is corresponding to the first geometrical transformation operation applied to the cell.

Another example (e.g., example 2) relates to a previous example (e.g., example 1) or to any other example, further comprising that the processing circuitry is to execute the machine-readable instructions to generate a third hash code of a second instance of the cell by applying a second mathematical operation to the first hash code, and wherein the second instance of the cell results from applying a second geometrical transformation operation to the cell during a second instantiation of the cell, and wherein the second mathematical operation is corresponding to the second geometrical transformation operation applied to the cell.

Another example (e.g., example 3) relates to a previous example (e.g., one of the examples 1 or 2) or to any other example, further comprising that the first hierarchical IC layout is a representation of an IC by planar geometric shapes representing components of the IC, wherein the planar geometric shapes are structured in layers of nested instances of one or more cells.

Another example (e.g., example 4) relates to a previous example (e.g., one of the examples 1 to 3) or to any other example, further comprising that the processing circuitry is to execute the machine-readable instructions to generate a hash code of the planar geometric shape of the cell by applying the hash function to the planar geometric shape.

Another example (e.g., example 5) relates to a previous example (e.g., one of the examples 1 to 4) or to any other example, further comprising that the processing circuitry is to execute the machine-readable instructions to generate the first hash code of the cell, by generating a hash code for all instances of cells and all planar geometric shapes in the cell and combining the resulting hash codes.

Another example (e.g., example 6) relates to a previous example (e.g., one of the examples 1 to 5) or to any other example, further comprising that the second hash code is equal to a hash code obtained by applying the hash function to the first instance of the cell.

Another example (e.g., example 7) relates to a previous example (e.g., one of the examples 1 to 6) or to any other example, further comprising that the hash function is based on a bivariate polynomial function.

Another example (e.g., example 8) relates to a previous example (e.g., one of the examples 1 to 7) or to any other example, further comprising that the hash function is based on a bivariate polynomial function, and wherein the exponents of the polynomial function are based on the coordinates of the planar geometric shape.

Another example (e.g., example 9) relates to a previous example (e.g., one of the examples 1 to 8) or to any other example, further comprising that the hash function is based on a bivariate polynomial function evaluated at a randomly chosen point.

Another example (e.g., example 10) relates to a previous example (e.g., one of the examples 1 to 9) or to any other example, further comprising that a hash code of the planar geometric shape is determined by applying the hash function according to a mathematical formula which is equivalent to the following formula:

$$hc = hash ( S ) = {\sum }_{\begin{matrix}vertical edges i \\ in the planar \\ geometric shape\end{matrix}} [ {u}^{{x}_{i}} ( {v}^{{y}_{i , 1}} - {v}^{{y}_{i , 2}} ) mod p ] + {{\sum }_{\begin{matrix}non - vertical , \\ non - horizontal \\ edges j in the \\ planar geometric \\ shape\end{matrix}}}_{} [ ( ( {u}^{{x}_{j , 1}} {v}^{{y}_{j , 1}} - {u}^{{x}_{j , 2}} {v}^{{y}_{j , 2}} ) {s}^{{a}_{j}} {t}^{{b}_{j}} mod p ]$$

wherein hash is the hash function, hc is the hash code of the planar geometric shape S, xᵢ, y_{i,1}, y_{i,2} are coordinates of the respective vertical edges i in the planar geometric shape S, x_{j,1}, y_{j,1}, x_{j,2}, y_{j,2} are coordinates of the respective non-vertical and non-horizontal edges j in the planar geometric shape S, aⱼ and bⱼ are a numerator and denominator of a reduced fraction of a slope between the two vertices of a respective edge j, u, v, s and t are randomly chosen but fixed numbers of bit-length N, N is an integer number and p is the largest prime number less than 2^{N}.

Another example (e.g., example 11) relates to a previous example (e.g., one of the examples 1 to 10) or to any other example, further comprising that the first and/or second mathematical operation corresponding the first and/or second geometrical transformation operation of the cell during first and/or second instantiation of the cell is based on the coordinates of the first and/or second geometrical transformation operation of the cell.

Another example (e.g., example 12) relates to a previous example (e.g., one of the examples 1 to 11) or to any other example, further comprising that the first and/or second geometrical transformation operation of the cell during first and/or second instantiation of the cell comprises shifting, rotating and/or mirroring the cell.

Another example (e.g., example 13) relates to a previous example (e.g., example 12) or to any other example, further comprising that the mathematical operation is shifting of the cell, wherein the shifting of the cell is determined according to a mathematical formula which is equivalent to the following formula:

hc₂=(hc₁·u^{dx}·v^{dy}) mod p

wherein hc₁ is the hash code of the cell, dx and dy are an offset in x-direction and y-direction applied to the cell during the first instantiation, hc 2 is the hash code of the first instance of the cell, u, v are randomly chosen but fixed numbers of bit-length N, N is an integer number and p is the largest prime number less than 2^{N}.

Another example (e.g., example 14) relates to a previous example (e.g., one of the examples 1 to 7) or to any other example, further comprising that the hash function is based on a bivariate polynomial function, wherein the variables of the polynomial function are based on the coordinates of the planar geometric shape.

Another example (e.g., example 15) relates to a previous example (e.g., one of the examples 1 to 7) or to any other example, further comprising that a hash code of the planar geometric shape comprises a list of hash values, wherein a hash value is determined by applying the hash function according to a mathematical formula which is equivalent to the following formula:

$$hash ( {S ( m , n )}_{i} ) = {h}_{{( m , n )}_{i}} = {\sum }_{( x , y ) integer coordinates in geometric shape} {x}^{n} {y}^{m}$$

wherein hash is the hash function, h_{(m,n)i} is a hash value in the list of hash values in the hash code hc of the planar geometric shape S, wherein a hash value h_{(m,n)i} is determined for each pair (m,n)ᵢ which satisfies (m+n)ᵢ<=N, where m and n are integers and N is a predetermined integer, x, y, are the coordinates for the respective planar geometric shape S.

Another example (e.g., example 16) relates to a previous example (e.g., one of the examples 1 to 15) or to any other example, further comprising that the processing circuitry is to execute the machine-readable instructions to generate a hash code for each instance of a cell in the first hierarchical IC layout, and generate a hash code for the first hierarchical IC layout by combining all the generated hash codes of all instances of all cells.

Another example (e.g., example 17) relates to a previous example (e.g., example 16) or to any other example, further comprising that the processing circuitry is to execute the machine-readable instructions to generate a hash code for a second hierarchical IC layout, and compare the first hierarchical IC layout and the second hierarchical IC layout for similarity by comparing the corresponding hash codes.

An example (e.g., example 18) relates to an apparatus comprising processing circuitry configured to obtain a first hierarchical IC layout comprising a first instance of a cell, wherein the cell from which the first instance is derived, comprises at least one planar geometric shape representing components of a first IC, and wherein the first instance of the cell results from applying a first geometrical transformation operation to the cell during a first instantiation of the cell, generate a first hash code of the cell based on a hash function, and generate a second hash code of the first instance of the cell by applying a first mathematical operation to the first hash code, wherein the first mathematical operation is corresponding to the first geometrical transformation operation applied to the cell.

An example (e.g., example 19) relates to a device comprising means for processing for obtaining a first hierarchical IC layout comprising a first instance of a cell, wherein the cell from which the first instance is derived, comprises at least one planar geometric shape representing components of a first IC, and wherein the first instance of the cell results from applying a first geometrical transformation operation to the cell during a first instantiation of the cell, generating a first hash code of the cell based on a hash function, and generating a second hash code of the first instance of the cell by applying a first mathematical operation to the first hash code, wherein the first mathematical operation is corresponding to the first geometrical transformation operation applied to the cell.

An example (e.g., example 21) relates to a method comprising Obtaining a first hierarchical IC layout comprising a first instance of a cell, wherein the cell from which the first instance is derived, comprises at least one planar geometric shape representing components of a first IC, and wherein the first instance of the cell results from applying a first geometrical transformation operation to the cell during a first instantiation of the cell, generating a first hash code of the cell based on a hash function, and generating a second hash code of the first instance of the cell by applying a first mathematical operation to the first hash code, wherein the first mathematical operation is corresponding to the first geometrical transformation operation applied to the cell.

Another example (e.g., example 22) relates to generating a third hash code of a second instance of the cell by applying a second mathematical operation to the first hash code, and wherein the second instance of the cell results from applying a second geometrical transformation operation to the cell during a second instantiation of the cell, and wherein the second mathematical operation is corresponding to the second geometrical transformation operation applied to the cell.

Another example (e.g., example 23) relates to a previous example (e.g., one of the examples 21 or 22) or to any other example, further comprising that the first hierarchical IC layout is a representation of an IC by planar geometric shapes representing components of the IC, wherein the planar geometric shapes are structured in layers of nested instances of one or more cells.

Another example (e.g., example 24) relates to a previous example (e.g., one of the examples 21 or 23) or to any other example further comprising generating a hash code of the planar geometric shape of the cell by applying the hash function to the planar geometric shape.

Another example (e.g., example 25) relates to a previous example (e.g., one of the examples 21 or 24) or to any other example further comprising generating the first hash code of the cell, by generating a hash code for all instances of cells and all planar geometric shapes in the cell and combining the resulting hash codes.

Another example (e.g., example 26) relates to a previous example (e.g., one of the examples 21 to 25) or to any other example, further comprising that the second hash code is equal to a hash code obtained by applying the hash function to the first instance of the cell.

Another example (e.g., example 27) relates to a previous example (e.g., one of the examples 21 to 26) or to any other example, further comprising that the hash function is based on a bivariate polynomial function.

Another example (e.g., example 28) relates to a previous example (e.g., one of the examples 21 to 27) or to any other example, further comprising that the hash function is based on a bivariate polynomial function, wherein the exponents of the polynomial function are based on the coordinates of the planar geometric shape.

Another example (e.g., example 29) relates to a previous example (e.g., one of the examples 21 to 28) or to any other example, further comprising that the hash function is based on a bivariate polynomial function evaluated at a randomly chosen point.

Another example (e.g., example 30) relates to a previous example (e.g., one of the examples 21 to 29) or to any other example, further comprising that a hash code of the planar geometric shape is determined by applying the hash function according to a mathematical formula which is equivalent to the following formula:

$$hc = hash ( S ) = {\sum }_{\begin{matrix}vertical edges i \\ in the planar \\ geometric shape\end{matrix}} [ {u}^{{x}_{i}} ( {v}^{{y}_{i , 1}} - {v}^{{y}_{i , 2}} ) mod p ] + {\sum }_{\begin{matrix}non - vertical , \\ non - horizontal \\ edges j in the \\ planar geometric \\ shape\end{matrix}} [ ( ( {u}^{{x}_{j , 1}} {v}^{{y}_{j , 1}} - {u}^{{x}_{j , 2}} {v}^{{y}_{j , 2}} ) {s}^{{a}_{j}} {t}^{{b}_{j}} mod p ]$$

wherein hash is the hash function, hc is the hash code of the planar geometric shape S, xᵢ, y_{i,1}, y_{i,2} are coordinates of the respective vertical edges i in the planar geometric shape S, x_{j,1}y_{j,1}, x_{j,2}, y_{j,2} are coordinates of the respective non-vertical and non-horizontal edges j in the planar geometric shape S, aⱼ and bⱼ are a numerator and denominator of a reduced fraction of a slope between the two vertices of a respective edge j, u, v, s and t are randomly chosen but fixed numbers of bit-length N, N is an integer number and p is the largest prime number less than 2^{N}.

Another example (e.g., example 31) relates to a previous example (e.g., one of the examples 21 to 30) or to any other example, further comprising that the first and/or second mathematical operation corresponding the first and/or second geometrical transformation operation of the cell during first and/or second instantiation of the cell is based on the coordinates of the first and/or second geometrical transformation operation of the cell.

Another example (e.g., example 32) relates to a previous example (e.g., one of the examples 21 to 31) or to any other example, further comprising that the first and/or second geometrical transformation operation of the cell during first and/or second instantiation of the cell comprises shifting, rotating and/or minoring the cell.

Another example (e.g., example 33) relates to a previous example (e.g., example 32) or to any other example, further comprising that the mathematical operation is shifting of the cell, wherein the shifting of the cell is determined according to a mathematical formula which is equivalent to the following formula:

hc₂=(hc₁·u^{dx}·v^{dy})mod p

wherein hc₁ is the hash code of the cell, dx and dy are an offset in x-direction and y-direction applied to the cell during the first instantiation, hc₂ is the hash code of the first instance of the cell, u, v are randomly chosen but fixed numbers of bit-length N, N is an integer number and p is the largest prime number less than 2^{N}.

Another example (e.g., example 34) relates to a previous example (e.g., one of the examples 21 to 27) or to any other example, further comprising that the hash function is based on a bivariate polynomial function, wherein the variables of the polynomial function are based on the coordinates of the planar geometric shape.

Another example (e.g., example 35) relates to a previous example (e.g., one of the examples 21 to 27) or to any other example, further comprising that a hash code of the planar geometric shape comprises a list of hash values, wherein a hash value is determined by applying the hash function according to a mathematical formula which is equivalent to the following formula:

$$hash ( {S ( m , n )}_{i} ) = {h}_{{( m , n )}_{i}} = {\sum }_{( x , y ) integer coordinates in geometric shape} {x}^{n} {y}^{m}$$

wherein hash is the hash function, h(m,n)i is a hash value in the list of hash values in the hash code of the planar geometric shape S, wherein a hash value h(m,n)i is determined for each pair (m,n)ᵢ which satisfies (m+n)ᵢ<=N, where m and n are integers and N is a predetermined integer, x, y, are the coordinates for the respective planar geometric shape S.

Another example (e.g., example 36) relates to generating a hash code for each instance of a cell in the first hierarchical IC layout, and generate a hash code for the first hierarchical IC layout by combining all the generated hash codes of all instances of all cells.

Another example (e.g., example 37) relates to generating a hash code for a second hierarchical IC layout, and compare the first hierarchical IC layout and the second hierarchical IC layout for similarity by comparing the corresponding hash codes.

Another example (e.g., example 38) relates to a non-transitory machine-readable storage medium including program code, when executed, to cause a machine to perform the method of examples 21 to 37.

Another example (e.g., example 39) relates to a computer program having a program code for performing the method of examples 21 to 37 when the computer program is executed on a computer, a processor, or a programmable hardware component.

Another example (e.g., example 40) relates to a machine-readable storage including machine readable instructions, when executed, to implement a method or realize an apparatus as described in any pending example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for integrated circuit, IC, layouting comprising interface circuitry, machine-readable instructions, and processing circuitry to execute the machine-readable instructions to:
obtain a first hierarchical IC layout comprising a first instance of a cell, wherein the cell from which the first instance is derived comprises at least one planar geometric shape representing components of a first IC, and wherein the first instance of the cell results from applying a first geometrical transformation operation to the cell during a first instantiation of the cell;
generate a first hash code of the cell based on a hash function; and
generate a second hash code of the first instance of the cell by applying a first mathematical operation to the first hash code, wherein the first mathematical operation is corresponding to the first geometrical transformation operation applied to the cell.

2. The apparatus according to claim 1, wherein the processing circuitry is to execute the machine-readable instructions to:
generate a third hash code of a second instance of the cell by applying a second mathematical operation to the first hash code, and
wherein the second instance of the cell results from applying a second geometrical transformation operation to the cell during a second instantiation of the cell, and
wherein the second mathematical operation is corresponding to the second geometrical transformation operation applied to the cell.

3. The apparatus according to claim 1, wherein the first hierarchical IC layout is a representation of an IC by planar geometric shapes representing components of the IC, wherein the planar geometric shapes are structured in layers of nested instances of one or more cells.

4. The apparatus according to claim 1, wherein the processing circuitry is to execute the machine-readable instructions to generate a hash code of the planar geometric shape of the cell by applying the hash function to the planar geometric shape.

5. The apparatus according to claim 1, wherein the processing circuitry is to execute the machine-readable instructions to generate the first hash code of the cell, by generating a hash code for all instances of cells and all planar geometric shapes in the cell and combining the resulting hash codes.

6. The apparatus according to claim 1, wherein the second hash code is equal to a hash code obtained by applying the hash function to the first instance of the cell.

7. The apparatus according to claim 1, wherein the hash function is based on a bivariate polynomial function.

8. The apparatus according to claim 1, wherein the hash function is based on a bivariate polynomial function, and wherein the exponents of the polynomial function are based on the coordinates of the planar geometric shape.

9. The apparatus according to claim 1, wherein the hash function is based on a bivariate polynomial function evaluated at a randomly chosen point.

10. The apparatus according to claim 1, wherein a hash code of the planar geometric shape is determined by applying the hash function according to a mathematical formula which is equivalent to the following formula:
$$hc = hash ( S ) = {\sum }_{\begin{matrix}vertical edges i \\ in the planar \\ geometric shape\end{matrix}} [ {u}^{{x}_{i}} ( {v}^{{y}_{i , 1}} - {v}^{{y}_{i , 2}} ) mod p ] + {{\sum }_{\begin{matrix}non - vertical , \\ non - horizontal \\ edges j in the \\ planar geometric \\ shape\end{matrix}}}_{} [ ( ( {u}^{{x}_{j , 1}} {v}^{{y}_{j , 1}} - {u}^{{x}_{j , 2}} {v}^{{y}_{j , 2}} ) {s}^{{a}_{j}} {t}^{{b}_{j}} mod p ]$$
wherein hash is the hash function, hc is the hash code of the planar geometric shape S, xᵢ, y_{i,1}, y_{i,2} are coordinates of the respective vertical edges i in the planar geometric shape S, x_{j,1}, y_{j,1}, x_{j,2}, y_{j,2} are coordinates of the respective non-vertical and non-horizontal edges j in the planar geometric shape S, aⱼ and bⱼ are a numerator and denominator of a reduced fraction of a slope between the two vertices of a respective edge j, u, v, s and t are randomly chosen but fixed numbers of bit-length N, N is an integer number and p is the largest prime number less than 2^{N}.

11. The apparatus according to claim 1, wherein the first and/or second mathematical operation corresponding the first and/or second geometrical transformation operation of the cell during first and/or second instantiation of the cell is based on the coordinates of the first and/or second geometrical transformation operation of the cell.

12. The apparatus according to claim 1, wherein the first and/or second geometrical transformation operation of the cell during first and/or second instantiation of the cell comprises shifting, rotating and/or mirroring the cell.

13. The apparatus according to claim 12, wherein the mathematical operation is shifting of the cell, wherein the shifting of the cell is determined according to a mathematical formula which is equivalent to the following formula:
hc₂=(hc₁·u^{dx}·v^{dy})mod p
wherein hc₁ is the hash code of the cell, dx and dy are an offset in x-direction and y-direction applied to the cell during the first instantiation, hc₂ is the hash code of the first instance of the cell, u, v are randomly chosen but fixed numbers of bit-length N, N is an integer number and p is the largest prime number less than 2^{N}.

14. The apparatus according to claim 1, wherein the hash function is based on a bivariate polynomial function, wherein the variables of the polynomial function are based on the coordinates of the planar geometric shape.

15. The apparatus according to claim 1, wherein a hash code of the planar geometric shape comprises a list of hash values, wherein a hash value is determined by applying the hash function according to a mathematical formula which is equivalent to the following formula:
$$hash ( {S ( m , n )}_{i} ) = {h}_{{( m , n )}_{i}} = {\sum }_{( x , y ) integer coordinates in geometric shape} {x}^{n} {y}^{m}$$
wherein hash is the hash function, h_{(m,n)i} is a hash value in the list of hash values in the hash code hc of the planar geometric shape S, wherein a hash value h_{(m,n)i} is determined for each pair (m,n)ᵢ which satisfies (m+n)ᵢ<=N, where m and n are integers and N is a predetermined integer, x, y, are the coordinates for the respective planar geometric shape S.

16. The apparatus according to claim 1, wherein the processing circuitry is to execute the machine-readable instructions to:
generate a hash code for each instance of a cell in the first hierarchical IC layout; and
generate a hash code for the first hierarchical IC layout by combining all the generated hash codes of all instances of all cells.

17. The apparatus according to claim 16, wherein the processing circuitry is to execute the machine-readable instructions to:
generate a hash code for a second hierarchical IC layout; and
compare the first hierarchical IC layout and the second hierarchical IC layout for similarity by comparing the corresponding hash codes.

18. A method comprising:
Obtaining a first hierarchical IC layout comprising a first instance of a cell, wherein the cell from which the first instance is derived, comprises at least one planar geometric shape representing components of a first IC, and
wherein the first instance of the cell results from applying a first geometrical transformation operation to the cell during a first instantiation of the cell;
generating a first hash code of the cell based on a hash function; and
generating a second hash code of the first instance of the cell by applying a first mathematical operation to the first hash code, wherein the first mathematical operation is corresponding to the first geometrical transformation operation applied to the cell.

19. The method according to claim 18 further comprising:
generating a third hash code of a second instance of the cell by applying a second mathematical operation to the first hash code, and
wherein the second instance of the cell results from applying a second geometrical transformation operation to the cell during a second instantiation of the cell, and
wherein the second mathematical operation is corresponding to the second geometrical transformation operation applied to the cell.

20. A non-transitory machine-readable storage medium including program code, when executed, to cause a machine to perform the method of claim 18.
